(19) United States
(12) Patent Application Publication
(10) Pub. No.: US 2014/0352535 A1
(43) Pub. Date: Dec. 4, 2014

(54) ELECTRONIC FINE DUST SEPARATOR

(71) Applicant: Peter Oertmann, Schulzendorf (DE)

(72) Inventor: Peter Oertmann, Schulzendorf (DE)

(21) Appl. No.: 14/238,883

(22) PCT Filed: Aug. 13, 2012
(86) PCT No.: PCT/DE2012/000839

§ 371 Date: Feb. 14, 2014

(30) Foreign Application Priority Data
Aug. 15, 2011 (DE) 10 2011 110 805.3
Aug. 15, 2011 (DE) 20 2011 104 657.9

(51) Int. Cl. B03C 3/09; G03G 21/20; B03C 3/36

(52) U.S. Cl. CPC B03C 3/09; B03C 3/366; G03G 21/20
USPC 95/78; 95/79; 95/80; 96/60

(57) ABSTRACT

A method and to a device for the electrostatic separation of fine dust particles from gases that flow through a housing (1) containing perforated plates (6) and electrodes (4, 5). An electric field is created between the electrode (4) on the inflow opening side and the electrode or electrodes (5) having positive polarity on the outflow side. The removal of negatively charged fine dust particles (9) is carried out by deposition on the inflow side of the perforated plates (6), and the removal of positively charged fine dust particles (11) is carried out on the outflow side. Fine dust particles without charge (10) are charged after the last perforated plate (6) in an ionisation chamber (8) and deposit on the outflow side of the last perforated plate (6).

The invention relates to an electronic fine dust separator which removes, in particular, fine dust particles in the range of 0.05-0.5 μm from gases and which can preferably be used as a fine dust separator during the cleaning of exhaust air from printing and copying technology.

A filter system for filtering the exhaust air during copying and printing processes, wherein the filter system has at least one flat-shaped fine dust filter made of paper, textile fabric or the like as well as a closing means which serves to fasten the filter system directly on the fine dust-emitting opening of the device, is known from DE 20 2007 011 263 U1.

The disadvantage of such filters is that they clog very quickly, the filtration resistance increases, therefore calling into question the functionality of the necessary ventilation (cooling).

The process of subjecting metal thread filters, sheet metal filters or steel wool arranged in a sleeve to a magnetic field, so that the fine dust is absorbed from the air on flowing through the sleeve, is also known from DE 20 2010 010 652 U1.

The background to these developments is the fact that minute, nanoscale particles are released by the transfer of the toner to the paper and the heating during the printing or copying process.

It is now deemed to be proven that laser printers and color copiers are among the greatest sources of fine dust. Fine dust is enormously harmful and can lead to various conditions including headaches, eye irritations and even cancer. Of particular interest are particle sizes of 0.05 μm-0.500 μm, as these are not excreted by the human body. However, the present invention is not limited to this application.

Electronic separators based on the principles of electrostatics are also known. These produce an electric charge. The dust particles are charged during the conducting of the air containing the dust particles through the electric field. The charged dust particles are transported to the precipitation electrode, adhere to said precipitation electrode and have to be removed at time intervals. By way of example, reference should be made here to DE 35 35 826 C2 or EP 1 033 171 B1.

Typically, such separators are based in one way or another on the ionization of the particles by an electric field of specified high voltage, so that they can be caught and held by electrostatic forces. The underlying technical mechanism of the charge generation is impact ionization, wherein free electrons present in the gas are greatly accelerated in the electric field of the corona in the environment of the spray electrode.

On striking gas molecules, additional electrons are either split off or attached to the gas molecules. In the first case, new free electrons and positive gas ions are created and, in the second case, negative gas ions are created. The positive gas ions are neutralized by the spray grid, while the negative charges (free electrons and gas ions) migrate towards the precipitation electrode.

The charging of a dust particle begins with its entry into the intermediate space through which the current discharge flows and is caused by the attachment of charges, when these collide with the grain of dust.

The charging process takes place in the case of the small dust particles (d<0.1 μm) by means of diffusion charging. In this case, the dust particles are charged by impact processes caused by the thermal motion of the gas molecules.

In smaller separators the particles <0.1 μm to approx. 40 μm are positively charged (Penney principle), because no ozone is produced. Negative charging of the dust particles is used in large industrial filters (Cottrell principle).

The Penney principle operates with a positive corona, which is generated around the corona discharge which has positive polarity. The ionization takes place at 12 to 14 KV. The precipitation zone has plate-type capacitors with alternating negatively and positively charged precipitation plates (Stieβ, Mechanische Verfahrenstechnik [Mechanical Method Engineering], Volume 2,Springer Berlin 1997, pp. 40, 45, DE 10 2006 033 945 B4).

Separators which operate in accordance with the Cottrell principle are disadvantageous for the stated purpose of filtering fine dust from the exhaust gas of printing and copying technology, because of the resulting ozone, as are those which operate exclusively in accordance with the Penney principle due to the risk of particle separation.

It is the object of the invention to propose a filter which removes fine dust particles, preferably in the order of 0.05 to 0.5 μm, from an air stream, reliably and over a defined period, without requiring maintenance. This object is achieved with the features of process claim 1 and device claim 6. Advantageous embodiments form the subject matter of the subordinate claims.

According to the invention the following process steps are at least provided in a method for the electrostatic separation of fine dust particles from gases containing fine dust particles, which flow through a housing containing perforated plates and electrodes, wherein at least the perforated plates are arranged transversely to the direction of flow:
creation of an electric field between the electrode on the inflow opening side and the electrode or electrodes having positive polarity on the outflow side,
removal of negatively charged fine dust particles by deposition on the inflow side of the perforated plates,
removal of positively charged fine dust particles by deposition on the outflow side of the perforated plates,
and removal of fine dust particles without charge or of fine dust particles with too low a charge after the last perforated plate by means of charging in an ionization chamber and deposition on the outflow side of the last perforated plate.

In an advantageous embodiment, the openings of adjacent perforated plates are staggered in the direction of flow, so that the gas flow exiting from an opening strikes a deposition surface for negatively charged fine dust particles of the following perforated plate and is deflected into the plane of the perforated plate. The exiting gas flow can then be formed, such that the gas flow, on striking the deposition surface, creates a suction towards the deposition surface at its center. In addition to the electrostatic forces, such an additional force leads to the deposition of fine dust particles.

Of course it would also be possible to provide a reverse electrode polarity, as a result of which the fine dust particles deposited on the deposition surfaces would then also have an opposite polarity. In this case, however, the ozone generated would have to be eliminated.

In a further advantageous embodiment the time available for the ionization can be increased by means of relaxation of the gas flow in the ionization chamber.

In a device for the electrostatic separation of fine dust particles from gases containing fine dust particles according to the invention, the following are at least arranged one after another and spaced apart in a housing in the direction of flow between an inflow opening and an outflow opening:
one electrode which is earthed or has negative polarity,
two or more perforated plates occupying the housing transversely to the direction of flow, where the openings of adjacent perforated plates are staggered in the direction of flow, and
one or more electrodes which has or have positive polarity.

An electric field exists between the electrode on the inflow opening side and the electrode or electrodes on the outflow opening side.

The electrodes used are configured in the form of a sieve or a net, preferably forming a flat surface.

In an advantageous embodiment, gas relaxation takes place in the ionization chamber due to a larger through-flow area of the electrodes compared with the last perforated plate, in the area of the outflow opening, with the result that the time available for ionization increases.

The voltage applied to the electrode or electrodes on the outflow opening side is such that impact ionization can be produced in the ionization chamber between the last perforated plate and the electrode or electrodes on the outflow opening side.

The perforated plates themselves are made of an electrically non-conductive material, preferably a plastic.

In a further advantageous embodiment provision is made for the distance between adjacent perforated plates and the size of the perforation to be adjusted to the gas flow such that, on striking the deposition surface of the following perforated plate, the exiting gas flow creates a suction towards the deposition surface at its center.

The fine dust separator is to be explained by an embodiment example, where:

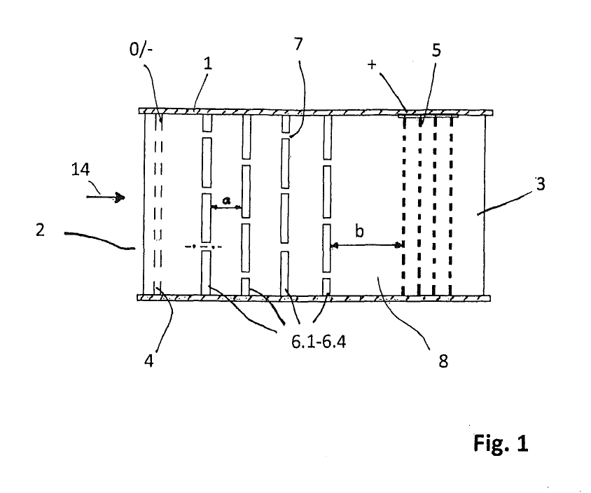

FIG. 1 shows the cross-section in the direction of flow,

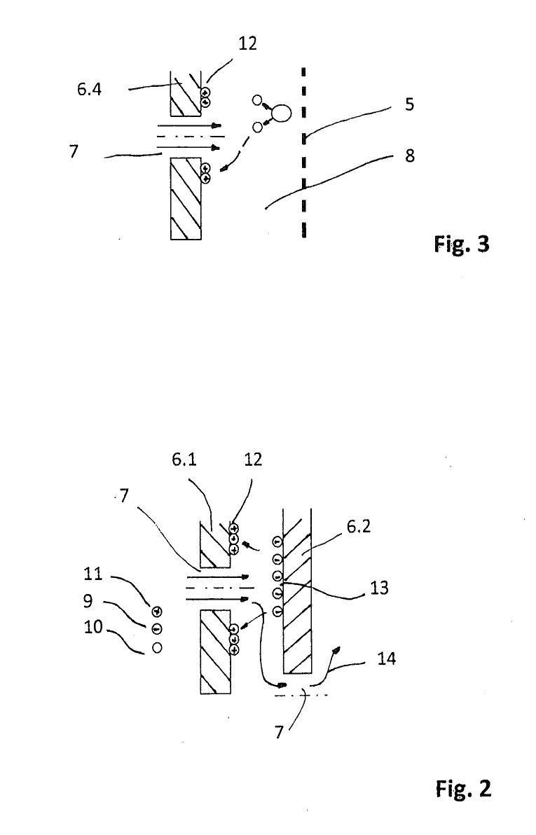

FIG. 2 shows the deposition of fine dust particles,

FIG. 3 shows the ionization chamber and

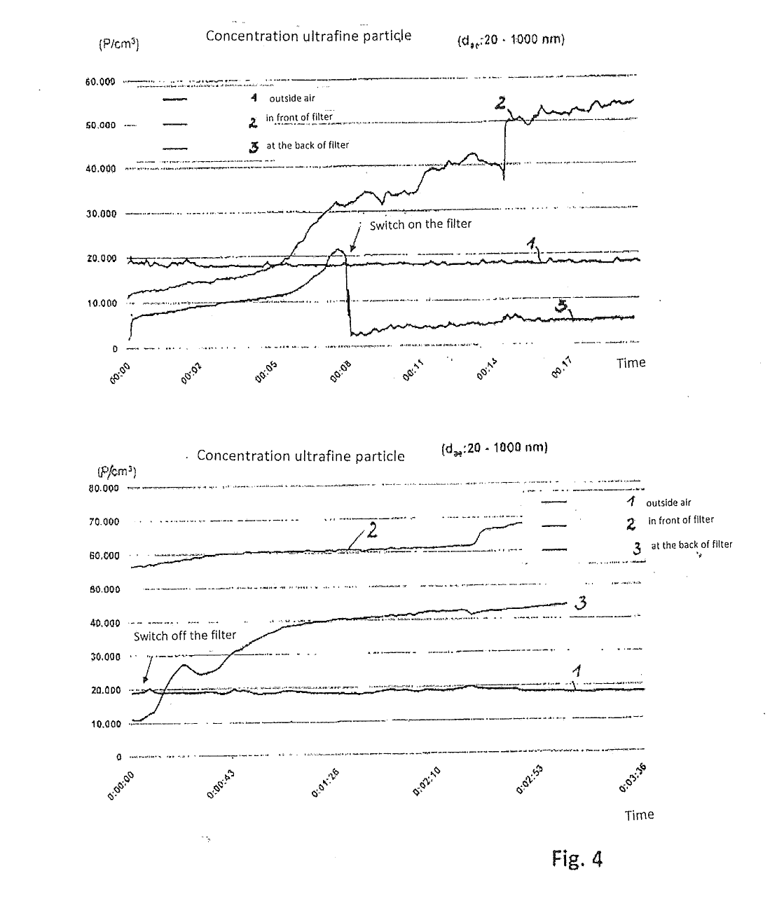

FIG. 4 shows the concentration profile of fine dust particles before and after the separator when the separator is switched on and following the shutdown of the separator.

FIG. 1 shows the cross-section of a preferred embodiment of the device for the electrostatic separation of fine dust particles 9, 10, 11 from exhaust air containing fine dust particles from copying technology in the direction of flow 14.

In the housing 1, the following are arranged one after another and spaced apart in the direction of flow 14 between the inflow opening 2 and the outflow opening 3:
an electrode 4 which is earthed or has negative polarity,
four perforated plates 6 occupying the housing 1 transversely to the direction of flow 14, wherein the openings 7 of adjacent perforated plates 6.1,6.2; 6.2,6.3 and 6.3,6.4 are staggered in the direction of flow 14, and
four electrodes 5 have positive polarity.

An electric field exists between the electrodes 4 and 5 due to the voltage of 8-14 KV applied to the electrodes.

The distance (a) between the plastic plates 6 in this embodiment example is 2-3 mm and the width (b) of the ionization chamber 8 is 2-4 mm.

The electrodes 4 and 5 are sieves with sieve wire diameters of 0.05 mm and smaller, each of which form a flat surface.

Due to the voltage of 8-14 KV applied to the electrodes 5, impact ionization can be produced in the ionization chamber 8 between the last perforated plate 6.4 and the electrodes 5.

The perforated plates 6 are made of an electrically non-conductive plastic, where the surface of the perforated plates 6 is roughened. The perforation diameter of the openings 7 of the perforated plates 6 is 1.5-2.2 mm, preferably 1.8-2 mm, and the distance between the centers of adjacent openings 7 from one another is approx. 6 mm.

The description indicates that the fine dust separator has a compact form. Despite this relatively small spatial extent of approx. 15-25 mm in the direction of flow 14, the separator allows e.g. fine dust adsorption during the production of around 100,000 copies, without the need for maintenance.

The mode of operation is to be explained with reference to FIG. 2 and FIG. 3.

FIG. 2 shows a detail of two perforated plates 6.1 and 6.2 located one behind the other. The openings 7 of the perforated plate 6.2 are staggered with respect to the openings 7 of the perforated plate 6.1.

The distance (a) between the perforated plates 6.1 and 6.2 is 2-3 mm and, with the perforation size, is adjusted to the gas flow such that the exiting gas flow, on striking the deposition surface 13 of the perforated plate 6.2, creates a suction towards the deposition surface 13 at its center.

After flowing through the earthed electrode 4, the exhaust air which is contaminated with fine dust particles 9, 10, 11 strikes the electrically non-conductive perforated plate 6.1 and enters the intermediate space between the perforated plates 6.1 and 6.2 through the openings 7. The fine dust particles either have a positive charge 11, a negative charge 9 or no charge 10.

On flowing into the intermediate space between the perforated plates 6.1 and 6.2, the fine dust particles 9, 10, 11 collide with the inflow side of the perforated plate 6.2, with the deposition surface 13 present here.

The forces of the electric field between the electrodes 4 and 5, flow forces and the suction forces explained above act on the fine dust particles 9, 10, 11.

On striking the deposition surface 13 of the inflow side of the perforated plate 6.2, significant fractions of fine dust particles with a negative charge remain stuck here.

The remaining fraction of fine dust particles rebounds from the deposition surface 13 and strikes the outflow side of the perforated plate 6.1. Due to the effect of the electric field, parts of the positively charged fine dust particles 11 are deposited on this outflow side on the deposition surfaces 12 present here.

The remaining fraction of fine dust particles reaches the intermediate space between the perforated plates 6.2 and 6.3 through the openings 7 of the perforated plate 6.2. The separation process is repeated here in the manner described previously.

A blockage of the openings 7 and the intermediate spaces respectively is avoided in that a reduction of the flow cross-section leads to greater flow rates, overcoming contact forces, and the fraction of fine dust particles flowing further into the next space increases.

In summary, it can therefore be established that the removal of negatively charged fine dust particles 9 is carried out by deposition on the inflow side of the perforated plates 6, and the removal of positively charged fine dust particles 11 is carried out by deposition on the outflow side of the perforated plates 6.

FIG. 3 shows the ionization chamber 8 between the last perforated plate 6.4 and the electrode 5, which has positive polarity and to which a voltage of 8-14 KV is applied.

Due to the separation of positively and negatively charged fine dust particles, only particles with a very weak charge or neutral fine dust particles 10 enter the ionization chamber 8. These fine dust particles 10 and the fine dust particles with low charge are positively charged in the ionization chamber by diffusion charging, with the result that they move in the direction of the outflow side of the last perforated plate 6 and become attached here.

The removal of fine dust particles without charge 10 or fine dust particles with too low a charge is therefore carried out after the last perforated plate by charging in an ionization chamber 8 and deposition on the outflow side of the last perforated plate 6.

The concentration profile of fine dust particles in front of and behind the separator over time is shown in FIG. 4. Separation rates of at least 90 to 96% are achieved with the proposed separator.

While the concentration of fine dust drops abruptly (graph 3) after switching on the separator and levels off at a virtually constant value (top fig.), the concentration increases significantly again when the separator is switched off (graph 3 in the bottom fig.).

### LIST OF REFERENCE NUMERALS

1 Housing

2 Inflow opening

3 Outflow opening

4 Electrode earthed or having negative polarity

5 Electrodes having positive polarity.

6 Perforated plates

7 Openings of the perforated plates

8 Ionization chamber

9 Fine dust particles negatively charged

10 Fine dust particles without charge

11 Fine dust particles positively charged

12 Deposition of positively charged fine dust particles

13 Deposition of negatively charged fine dust particles

14 Direction of flow

1. A method for the electrostatic separation of fine dust particles from gases containing fine dust particles, which flow through a housing containing perforated plates and electrodes, wherein at least the perforated plates are arranged transversely to the direction of flow, comprising:
creating an electric field between the electrode (4) on the inflow opening side and the electrode or electrodes (5) having positive polarity on the outflow side,
removing negatively charged fine dust particles (9) by deposition on the inflow side of the perforated plates (6),
removing positively charged fine dust particles (11) by deposition on the outflow side of the perforated plates (6), and
removing fine dust particles without charge (10) or of fine dust particles with too low a charge after the last perforated plate (6) by means of charging in an ionization chamber (8) and deposition on the outflow side of the last perforated plate (6).

2. The method according to claim 1, wherein the openings (7) of the perforated plates (6) are staggered in the direction of flow (14), such that the gas flow exiting from an opening (7) strikes a deposition surface (13) for negatively charged fine dust particles of the following perforated plate (7) and is deflected into the plane of the perforated plate.

3. The method according to claim 1, wherein the exiting gas flow, upon striking the deposition surface (13), creates a suction towards the deposition surface (13) at its center.

4. The method according to claim 1, wherein the polarity of the electrodes (4, 5) is reversed, as a result of which the deposition surfaces (12, 13) are coated with fine dust particles opposite in sign and ozone is eliminated on the outlet side of the separator.

5. The method according to claim 1, wherein gas relaxation takes place in the ionization chamber (8).

6. A device for the electrostatic separation of fine dust particles from gases containing fine dust particles, wherein the following are at least located one behind the other and spaced apart in a housing (1) in the direction of flow (14) between an inflow opening (2) and an outflow opening (3):
an electrode (4) which is earthed or which has negative polarity,
two or more perforated plates (6) occupying the housing (1) transversely to the direction of flow (14), wherein the openings (7) of adjacent perforated plates (6.1, 6.2) are staggered in the direction of flow (14),
one or more electrodes (5) which have positive polarity, and
a means for generating an electric field between the electrodes (4) and (5).

7. The device according to claim 6, wherein the electrodes (4) and (5) are configured in the form of a sieve or a net.

8. The device according to claim 6, wherein the electrodes (5) have a larger gas flow-through area than the last perforated plate (6.4).

9. The device according to claim 6, wherein impact ionization can be produced in the ionization chamber (8) between the last perforated plate (6) and the first electrode (5) by voltage applied to the electrodes (5).

10. The device according to claim 6, wherein the perforated plates (6) consist of an electrically non-conductive material.

11. The device according to claim 6, wherein the distance between adjacent perforated plates (6.1, 6.2) and the perforation size are adjusted to the gas flow such that the exiting gas flow, on striking the deposition surface (13) of the following perforated plate, creates a suction towards the deposition surface (13) at its center.

12. The device according to claim 6, wherein the surface of the perforated plates (6) is roughened.

13. The device according to claim 6, wherein the electrodes (4) and (5) are configured in the form of a sieve or a net forming a flat surface.

14. The device according to claim 6, wherein the perforated plates (6) consist of a plastic.
